(19) United States
(12) Patent Application Publication
(10) Pub. No.: US 2004/0145909 A1
(43) Pub. Date: Jul. 29, 2004

(54) Light device with incorporated path venting

(75) Inventors: Eric John Ognian, Canton, MI (US); Dean Bryant Bowles, Commerce, MI (US)

Correspondence Address: Thomas E. Wettermann, McDonnell Boehnen Hulbert & Berghoff, 32nd Floor, 300 S. Wacker Drive, Chicago, IL, 60606, US

(73) Assignee: North American Lighting, Inc., Farmington Hills, MI

(21) Appl. No.: 10/352,801

(22) Filed: Jan. 28, 2003

(51) Int. Cl. F21V 7/00

(52) U.S. Cl. 362/516

(57) ABSTRACT

A light device with incorporated tortuous path venting is provided. The light device includes a reflector that has a base. A portion of the surface of the base is recessed to define a circuitous path around a perimeter of the base. Also, a side channel is connected to the recessed surface such that the circuitous path and the side channel together provide an air pathway between an interior of the reflector and an exterior of the reflector when a covering is positioned over the base.

### FIELD OF INVENTION

The present invention relates to automotive lighting and, more particularly, to providing a venting path within an automotive light device.

### BACKGROUND

A concern that frequently arises during the design of light devices is the need to provide proper ventilation for an interior of a housing or body of the light device. While adequate ventilation is important for both light device functionality and appearance, the light device design should also take into account the prevention of fogging (or build up of condensation) of the light device lens. Condensation can occur if ambient temperature is lower than inside the light device and the humidity inside the light device becomes too high. From a light device design perspective, the ambient temperature is relatively unchangeable. Also, interior temperatures of a light device are oftentimes difficult to lower. However, proper ventilation may lower the humidity levels inside the light device. And most light designs usually have two or three air vents to lower humidity levels below condensation threshold levels.

Most light devices cannot be designed to be airtight, which may disallow any undesired fogging effects, because continuous warm-cold-warm-cold cycles due to turning a light source on and off, cause plastic reflectors to expand and retract. Therefore, cracks or crevices within the design can eventually form. This leads to the necessity of air vents within the light device.

In addition, it may be necessary to vent a light device to cool off the light source. For example, during use, a bulb of a typical lamp reaches relatively high temperatures, which can harm the light device. Heat transferred from the bulb can melt, deform, or otherwise damage the lamp housing surrounding the bulb, especially when the lamp housing is made from a plastic material.

However, one problem associated with the use of air vents is the unwanted penetration of water, dirt, dust and other contaminants from a surrounding ambient into the light device cavity. This concern is especially evident where the light device resides on the exterior of an automobile that is subject to high speeds, inclement weather, and high water pressure situations (e.g., a car wash).

Typical air vents in light devices have a number of manufacturing and design disadvantages. One popular means of providing an air vent involves using a rubber part or rubber “boot” with an incorporated air vent, to slide over a rear of the light device and to attach snuggly to a vent boss on the housing, which then allows air to pass between the inside and outside of the light device. Example air vents include macaroni tube shaped paths with mesh filters to block objects from entering. A problem with this design is that, where the rubber boot is an injection-molded device, i.e., manufactured by injecting plastic or rubber material into a cavity of a pre-made mold, creating an air vent in the mold can be difficult. Creating a passage of two complete or more 90° turns with a single tool injection molded component creates manufacturing complexities because it requires more than one die draw direction.

### SUMMARY

In accordance with an exemplary embodiment, a light device housing is provided. The light device housing includes a first portion, a second portion, and a covering. The second portion is coupled to the first portion. The second portion includes a first channel defined circuitously about its perimeter and a second channel, which couples to the first channel. The second channel traverses from the first channel to the first portion. The covering couples to the second portion such that the first channel provides an air pathway between the covering and the second portion.

In another respect, the exemplary embodiment may take the form of an automotive light device. The automotive light device includes an automotive light reflector and a sealing member. The automotive light device has a reflective portion and a base. The base has an air channel defined circuitously about a perimeter of an outer surface of the base. The air channel also traverses from the base to the reflective portion. The sealing member couples to the base such that the air channel provides a pathway between the sealing member and the base, and from an interior of the automotive light reflector to an exterior of the automotive light reflector.

In still another respect, the exemplary embodiment may take the form of a ventilated automotive light device. The ventilated automotive light device includes a ventilation device defined partly on a housing and partly by a covering coupled to the housing such that together the housing and the covering define a pathway from an interior of the housing to an exterior of the housing. The pathway comprises a first channel and a second channel. The first channel is defined circuitously about a perimeter of the housing such that the first channel provides a first portion of the pathway that is defined between the covering and the housing. The second channel couples to the first channel and provides a second portion of the pathway that is defined from the first channel to the exterior of the housing.

These as well as other features and advantages will become apparent to those of ordinary skill in the art by reading the following detailed description, with appropriate reference to the accompanying drawings.

### BRIEF DESCRIPTION OF FIGURES

Reference is made to the attached figures, wherein like reference numerals refer to like elements, and wherein:

FIG. 1A is a side view of one embodiment of a light device;

FIG. 1B is a plan view of the light device of FIG. 1A;

FIG. 1C is a perspective view of the light device of FIG. 1A;

FIG. 1D is a rear view of the light device of FIG. 1A;

FIG. 2 is a side view of one embodiment of a tortuous path airflow within a light device;

FIG. 3A is a side view of one embodiment of a tortuous path airflow within a light device;

FIG. 3B is another side view of one embodiment of the tortuous path airflow within the light device;

FIG. 3C is yet another side view of one embodiment of the tortuous path airflow within the light device; and

FIG. 3D is a rear view of one embodiment of a tortuous path airflow within a light device.

### DETAILED DESCRIPTION OF EXEMPLARY EMBODIMENTS

According to an exemplary embodiment, a tortuous vent pathway is included in a light device to disallow fogging effects on the light device lens and to cool off the light source. In addition, the vent pathway may be provided such that the light device is sealed to prevent the unwanted penetration of contaminants from a surrounding ambient environment into the light device.

In one example, the tortuous pathway may be created partly in a housing of the light device and partly by a base covering of the light device. A portion of a base of the housing may be recessed such that the pathway is formed between the housing and the base covering when the covering is positioned over the base.

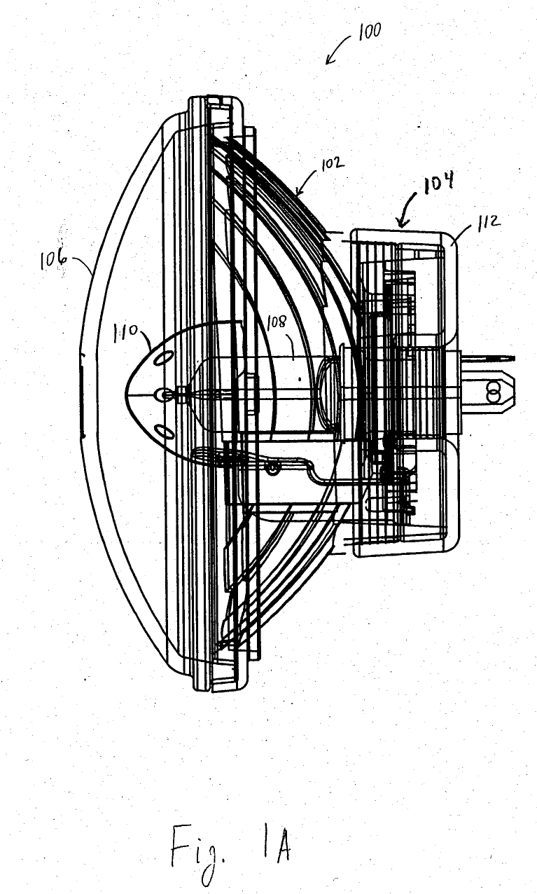

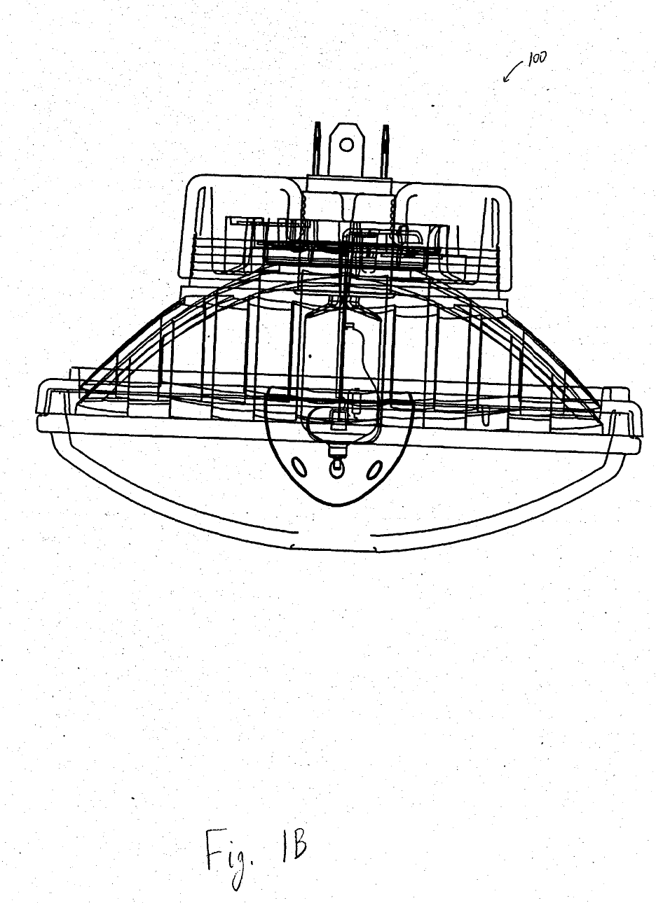

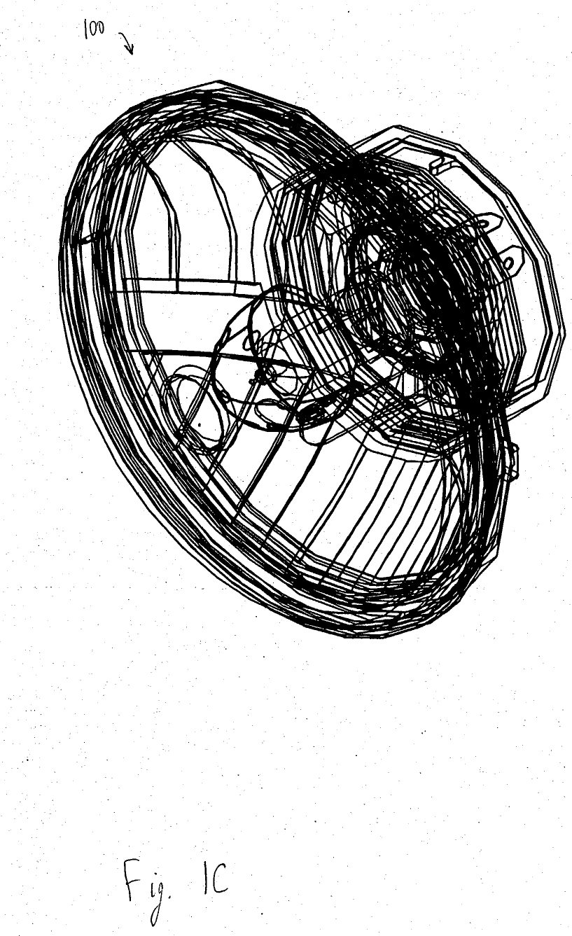

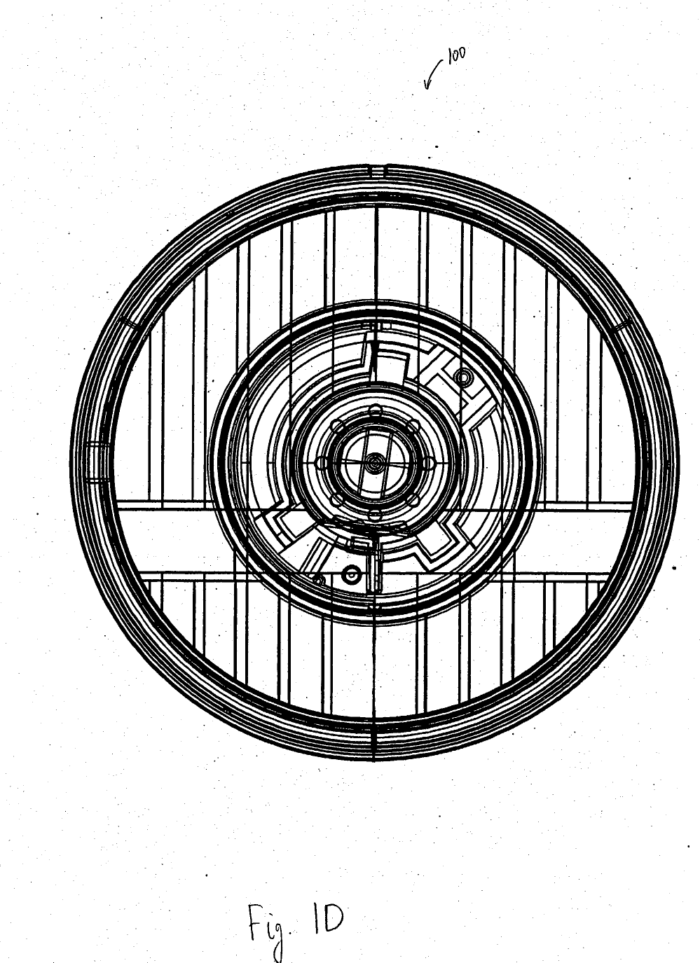

Referring now to the figures, and more particularly to FIG. 1A, a side view of one embodiment of a light device 100 is illustrated. It should be understood that the light device 100 illustrated in FIG. 1A and other arrangements described herein are set forth for purposes of example only, and other arrangements and elements can be used instead. In addition, some elements may be omitted altogether, depending on manufacturing, design, and/or consumer preferences.

By way of example, the light device 100 includes a first portion 102, a second portion 104, a lens 106, a light source 108, a bulb shield 110, and a covering 112. The first portion 102 and the second portion 104 may be an integral component. For example, the first portion may be a reflector and the second portion may be a base of the reflector. The first portion 102 couples to the lens 106 possibly using an adhesive material. The light source 108 is inserted into the first and second portions 102 and 104 through an aperture in the center of the portions 102 and 104. The bulb shield 110 is mounted such that the bulb shield 110 covers a center of the light source 108.

The light device 100 may comprise a plastic material or other non-conductive material. The light device 100 may also comprise a ceramic material as well, formed to have any desired shape and size. In one embodiment, the light device 100 is an automotive light device, such as a headlight, taillight, or side marker light.

The first portion 102 may include reflective optics on an inner surface such that light rays radiated from the light source 108 that contact the inner surface of the first portion 102 reflect outward through the lens 106. For example, the first portion 102 may be an automotive light reflector, such as a headlight reflector, a taillight reflector, or a side marker reflector. Other examples are possible as well.

The lens 106 may comprise any number or kind of optical elements to direct the light rays in a desired direction and in a desired fashion. For example, the lens 106 may include multi-faceted optics, and may be a parabolic reflector or a projection reflector. Other examples are possible as well.

The light source 108 may be any light bulb configured to be inserted within the light device 100. For example, the light source 108 may be an “HB2” light bulb. Additionally, the light source 108 could be a light emitting semiconductor device (LESD), such as a light emitting diode (LED). In one embodiment, the light source 108 may provide a light output that fulfills motor safety standards, such as the Federal Motor Vehicle Safety Standard (FMVSS).

The bulb shield 110 may comprise any material and may be formed into any shape to direct light as desired. As illustrated in FIG. 1A, the bulb shield 110 is positioned in the center of the first portion 102 of the light device 100.

The covering 112 may be any type of sealing member that slides over the second portion 104 of the light device 100 and attaches snuggly to the light device 100. For example, the covering 112 may be a rubber boot that seals the light device 100. However, the covering 112 may comprise other materials as well.

FIGS. 1B-1D illustrate alternate views of the light device 100. For example, FIG. 1B is a plan view of the light device 100, FIG. 1C is a perspective view of the light device 100, and FIG. 1D is a rear view of the light device 100.

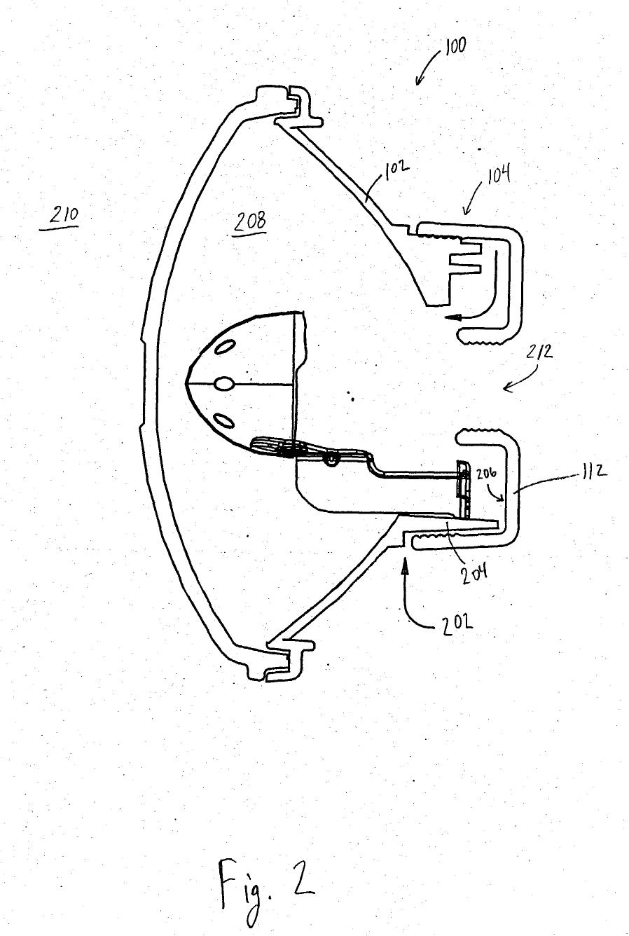

FIG. 2 is a side view of one embodiment of a tortuous path airflow within the light device 100. A tortuous path airflow 202 is formed between an outer surface 204 of the second portion 104 and an inner surface 206 of the covering 112. The tortuous path airflow 202 provides an air pathway between the covering 112 and the second portion 104, and subsequently between an interior 208 of the light device 100 and an exterior 210 of the light device 100. For example, air may flow from the interior 208 via a light source aperture 212 through the tortuous path airflow 202 to the exterior 210 of the light device 100.

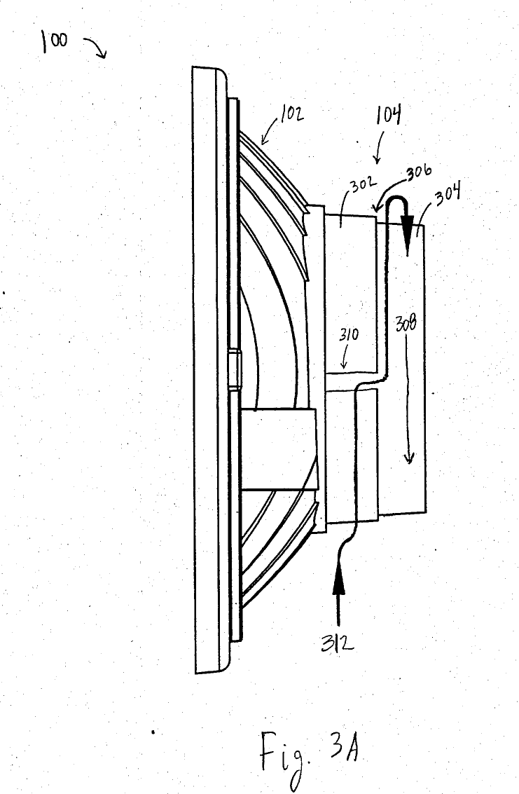

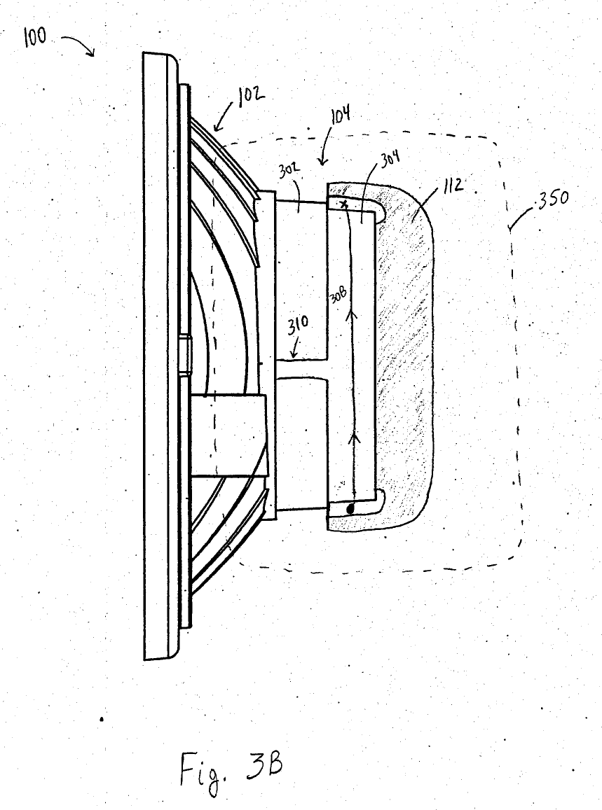

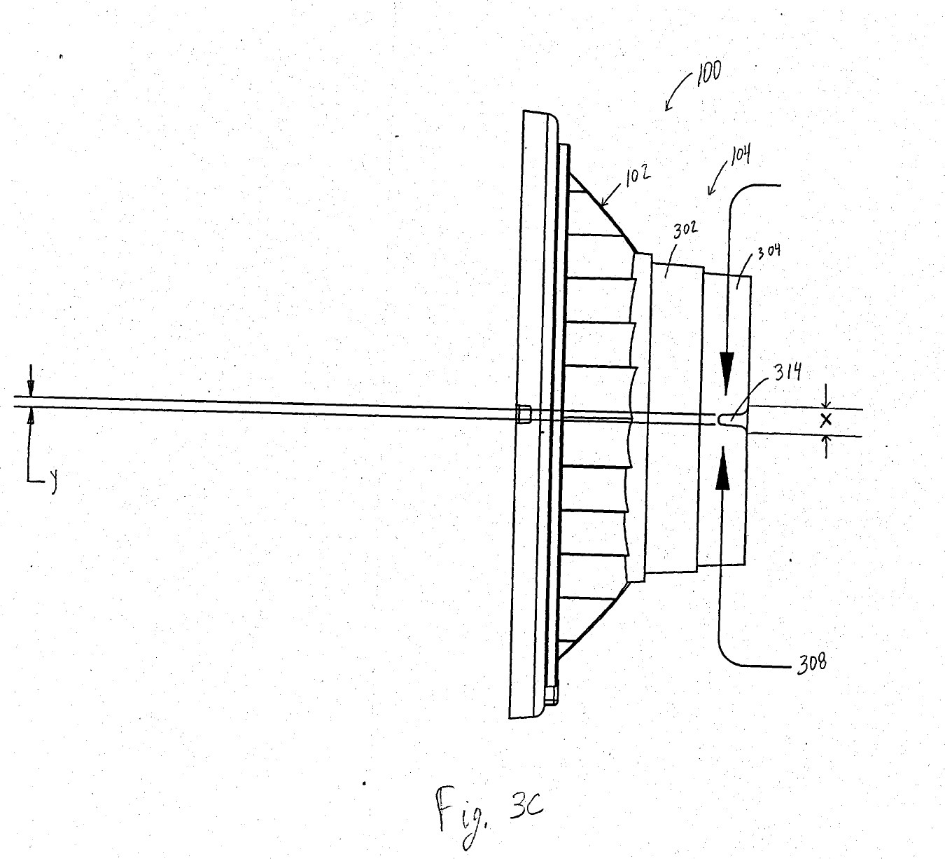

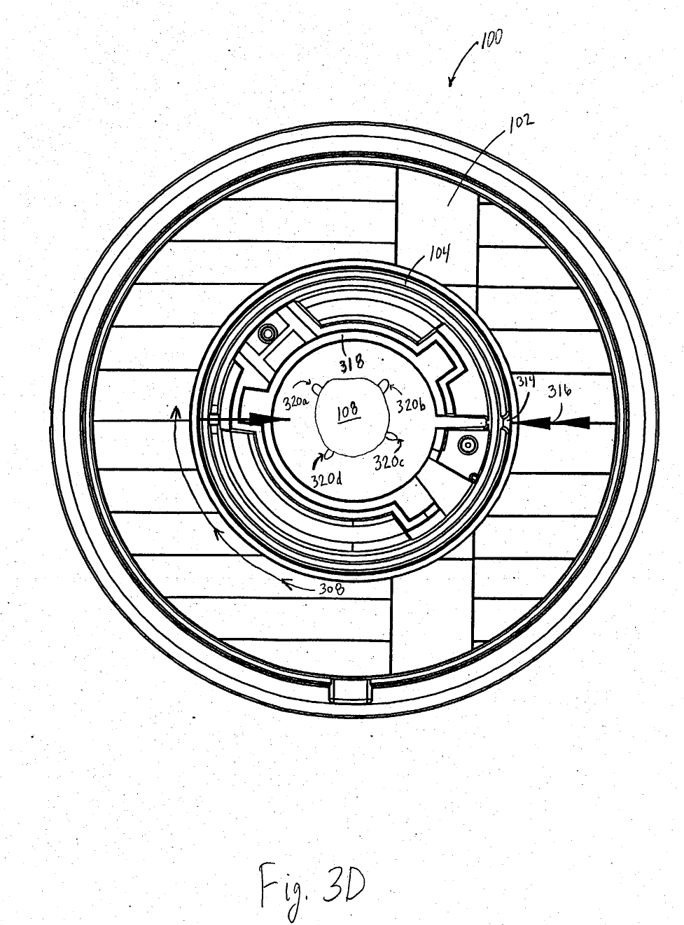

FIG. 3A is a side view of one embodiment of airflow within the light device 100. The second portion 104, e.g., base, is shown to include a non-recessed portion 302 and a recessed portion 304. The recessed portion 304 has a smaller circumference than the non-recessed portion 302. The covering (not shown) fits over the recessed portion 304 and abuts the non-recessed portion 302 at a recess interface 306.

The recessed portion 304 creates a first channel 308 defined circuitously about the perimeter of the second portion 104. The non-recessed portion 302 includes a second channel 310 defined to be a substantially straight line that traverses from the first channel 308 to the first portion 102. The second channel 310 may be a trench-like area or a recessed area on the non-recessed portion 302 of the second portion 104. A tortuous path airflow 312 is created by airflow through the first channel 308, e.g., around the perimeter of the recessed portion 304, and through the second channel 310.

The first and second channels 308 and 310 vent the light device 100 to allow air to flow into and out of the light device 100. Although FIG. 3A only illustrates one second channel 310, the non-recessed portion 302 of the second portion 104 may comprise more air channels.

FIG. 3B is another side view of one embodiment of the tortuous path airflow within the light device 100. FIG. 3B illustrates the covering 112 positioned over the recessed portion 304 of the second portion 104. The first channel 308 is created between the covering 112 and the recessed portion 304 of the light device 100. The thickness of the covering 112 and the differences in thickness between the recessed portion 304 and the non-recessed portion 302 will determine the thickness of the first channel 308.

In one embodiment, the light device 100 illustrated in FIG. 3B is a ventilated automotive light device. The light device 100 includes a ventilation device 350 defined partly on the second portion 104 and partly by the covering 112 such that together the second portion 104 and the covering 112 define the first channel 308, which couples to the second channel 310 to provide a pathway from the interior of the light device 100 to the exterior of the light device 100. As shown, air may flow circularly around the second portion 304 through the first channel 308, and subsequently through the second channel 310. Although the ventilation device 350 is shown within an automotive light device, the ventilation device 350 may be included within any type of light device or light device housing.

FIG. 3C is a top view of one embodiment of airflow within the light device 100. The recessed portion 304 of the second portion 104 includes a notch 314, e.g., an opening, that allows air from inside the light device 100 to flow outside of the light device 100 through a pathway underneath the covering (not shown) and around the recessed portion 304. The notch 314 provides a path from inside the light device 100 to outside the light device 100. The notch 314 is shown formed in a cone-like shape with the width increasing towards the end of the recessed portion 304. The wide portion of the notch 314 may be a width indicated by X and the narrow portion of the notch 314 may be a width indicated by Y. Although the light device 100 is shown to only include one notch 314, the light device 100 may comprise more notches to provide additional pathways for air to travel through. In addition, the notch 314 may be any desired shape or size depending on an amount of desired airflow through the light device 100.

FIG. 3D is a rear view of one embodiment of airflow within the light device 100. The rear of the light source 108 is shown mounted within a plate 318. The plate 318 includes notches 320a-d which allow air from the interior of the light device 100 to pass to the outside of the light device 100. Although four notches 320a-d are illustrated, more or fewer notches may be included within the plate 318.

FIG. 3D also illustrates the first channel 308, which is defined circuitously about the perimeter of the second portion 104. The airflow illustrated in FIG. 3D flows from the first channel 308 through the notch 314, illustrated by airflow 316, and through notches 320a-d into the light device 100.

Both notch 314, illustrated in FIG. 3C, and notches 320a-d, illustrated in FIG. 3D allow air to flow from an interior of the first portion 102 of the light device 100 to an area between the second portion 104 and the covering 112. The first and second channels 308 and 310 then allow air to flow to an exterior of the light device 100.

The airflow path is an air passage, which deters condensation build-up on the interior of the light device 100 and, at the same time, allows air transfer between the light device 100 and the ambient environment to equalize pressure and, if applicable, transfer heat. In other words, this allows the light device 100 to “breathe” while also reducing the potential for fogging and condensation.

While exemplary embodiments have been described, persons of skill in the art will appreciate that variations may be made without departure from the scope and spirit of the invention. This true scope and spirit is defined by the appended claims, which may be interpreted in light of the foregoing.

What is claimed is:

1. A light device housing comprising:
a first portion;
a second portion having a perimeter and being coupled to the first portion, wherein the second portion includes a first channel defined circuitously about the perimeter and a second channel coupled to the first channel, the second channel traversing from the first channel to the first portion; and
a covering coupled to the second portion such that the first channel provides an air pathway between the covering and the second portion.

2. The light device housing of claim 1, wherein the first portion is a reflector and the second portion is a base of the reflector.

3. The light device housing of claim 1, wherein the first portion and the second portion include a light source aperture.

4. The light device housing of claim 1, wherein the covering is a rubber boot.

5. The light device housing of claim 1, wherein the second channel traverses from the first channel to the first portion along a substantially straight line.

6. The light device housing of claim 1, wherein the first channel is defined by a recessed surface of the perimeter of the second portion such that the second portion comprises the recessed surface and a non-recessed surface.

7. The light device housing of claim 6, wherein the covering abuts the non-recessed surface.

8. The light device housing of claim 6, wherein the first channel is defined through the non-recessed surface.

9. The light device housing of claim 6, wherein the recessed surface of the second portion includes an opening that allows air to pass from an interior of the light device housing to an exterior of the light device housing.

10. The light device housing of claim 9, wherein the first channel includes the opening.

11. An automotive light device comprising:
an automotive light reflector having a reflective portion and a base, the base having an air channel defined circuitously about a perimeter of an outer surface of the base, the air channel also traversing from the base to the reflective portion; and
a sealing member coupled to the base such that the air channel provides a pathway between the sealing member and the base and from an interior of the automotive light reflector to an exterior of the automotive light reflector.

12. The automotive light device of claim 11, wherein the automotive light reflector is a reflector selected from the group consisting of a headlight reflector, a taillight reflector, and a side marker reflector.

13. The automotive light device of claim 11, wherein the air channel is defined by a recessed portion in the outer surface of the base.

14. The automotive light device of claim 11, wherein the automotive light reflector comprises a light source aperture.

15. The automotive light device of claim 14, further comprising a light source positioned in the light source aperture.

16. The automotive light device of claim 15, wherein the base of the automotive light reflector includes a plate, and wherein the plate includes at least one notch that allows air from the interior of the automotive light reflector to pass to the exterior of the automotive light reflector by passing through the pathway between the sealing member and the base.

17. The automotive light device of claim 11, wherein the sealing member is a rubber boot.

18. The automotive light device of claim 11, further comprising a lens coupled to the reflective portion of the automotive light reflector.

19. The automotive light device of claim 11, further comprising a bulb shield coupled to the base of the automotive light reflector.

20. A ventilated automotive light device comprising:
a ventilation device defined partly on a housing and partly by a covering coupled to the housing such that together the housing and the covering define a pathway from an interior of the housing to an exterior of the housing, wherein the pathway comprises:
a first channel defined circuitously about a perimeter of the housing such that the first channel provides a first portion of the pathway being defined between the covering and the housing; and
a second channel coupled to the first channel, the second channel providing a second portion of the pathway being defined from the first channel to the exterior of the housing.

21. The ventilated automotive light device of claim 20, wherein the ventilation device includes a light source aperture.

22. The ventilated automotive light device of claim 20, wherein the first channel is defined by a recessed portion of the housing.
